(19) United States
(12) Patent Application Publication
(10) Pub. No.: US 2025/0243971 A1
(43) Pub. Date: Jul. 31, 2025

(54) Mounting system for a tablet

(71) Applicant: Displine GmbH, Weisbaden (DE)

(72) Inventors: Piotr STANCZYK, Weisbaden (DE); Bartlomiej NEDZI, Radom (PL)

(21) Appl. No.: 19/037,435

(22) Filed: Jan. 27, 2025

(30) Foreign Application Priority Data
Jan. 26, 2024 (DE) 202024100408.6

(51) Int. Cl. F16M 13/02; F16B 1/00

(52) U.S. Cl. CPC F16M 13/02; F16B 1/00; F16B 2200/83

(57) ABSTRACT

The invention pertains to a mounting system for a tablet comprising: a frame member; a back plate which is partially surrounded by the frame member, wherein the frame member and the back plate define a receiving space for the tablet on an inner side of the frame member; a guide which extends at least partially on the inner side of the frame member and is formed for insertion and receiving of the tablet in the receiving space; a rigid cover plate which is detachably connected to the back plate and at least partially covers the receiving space; and a covering layer made of leather, imitation leather or non-woven fabric, which at least partially covers the rigid cover plate on a side facing away from the back plate and which is firmly connected to the rigid cover plate.

The invention relates to a mounting system for a tablet.

In the state of the art, it is known to manufacture mounting appliances for tablets, whereby the tablets can be held in a frame. The frame can, for example, be designed as a wall mount or table mount and have a snap or clip connection to securely hold the tablet in it. However, the insertion of the tablet is complicated in view of the snap or clip connection and the snap or clip connection can damage the edge of the tablet.

A further mounting appliance for tablets is disclosed in US20170003712 A1. In this known mounting appliance, the tablet is inserted or pushed into the side guides of the frame via the open side of a frame and secured via a clip provided on the open side of the frame. When the tablet is inserted or pushed in, it can be damaged by the side guides.

Other mounting systems with a frame open on one side and a back plate attached to the frame are also known in the prior art, with the frame having side guides as in US20170003712. In such known mounting systems, good stability is ensured due to the back plate, as the back plate closes the frame over its entire rear surface. However, with such mounting systems, the tablet can be damaged by the back plate and/or the side guides when it is inserted or pushed into the frame.

The object of the present invention is to provide an improvement or an alternative to the prior art. In particular, a stable mounting system with an improved mounting appliance for the tablet is to be provided, in which the tablet is not damaged during its insertion or sliding in.

In the context of this object, a further object of the invention is to provide a mounting system which has a stable frame which ensures gentle insertion of the tablet, wherein the rear of the frame is at least partially closed to maintain stability. The rear side of the frame is intended to ensure both the gentle insertion of the tablet and the stability of the frame. In the context of the above object, the rear side of the frame should also be able to be easily formed or designed in various ways without impairing the stability of the frame.

According to a first aspect, the object set is achieved by a mounting system for a tablet, wherein the mounting system comprises the following: a frame member; a back plate partially surrounded by the frame member, the frame member and the back plate defining a receiving space for the tablet on an inner side of the frame member; a guide extending at least partially on the inner side of the frame member and configured for inserting and receiving the tablet into the receiving space; a rigid cover plate which is detachably connected to the back plate and at least partially covers the receiving space; and a covering layer made of leather, imitation leather or non-woven fabric which at least partially covers the rigid cover plate on a side facing away from the back plate and which is firmly connected to the rigid cover plate. The combination of back plate, rigid cover plate and covering layer provides a stable arrangement that allows the tablet to be inserted into the frame without damage. Damage to the tablet when it is held in the mounting system is also avoided due to the nature of the covering layer. The detachable design of the rigid cover plate also allows the rigid cover plate and covering layer to be easily replaced, so that various covering layers with different surfaces can be provided to guide and hold the tablet. Synergistically, the rigid cover plate can simultaneously cover receptacles, openings or holes in the back plate, such as through-holes for receiving screws for wall mounting of a wall version of the mounting system or through-holes for mounting a support of the table version or recessed receptacles for magnets or other openings. The same applies to any attachments of a support in a table version of the mounting system. The combination of rigid cover plate and soft covering layer makes it easy to remove the cover plate and covering layer from the receiving space.

According to the invention, the guide can have a guiding function when the tablet is inserted into the frame member and/or a holding function when the tablet is inserted.

According to the invention, the term “frame member” refers to a partial frame whose front and rear sides are open. The back plate according to the invention closes the frame member completely or partially at the rear, so that at least the front remains open and the tablet is accessible from the front. According to the invention, the frame member and the rear side can be formed in one piece or integral, whereby the one-piece embodiment increases the stability of the mounting system and facilitates its manufacture. However, according to the invention, it is also conceivable that the frame member and the rear side are manufactured as separate elements in order to be subsequently firmly joined to one another to form an integral structure.

Preferably, the covering layer completely covers the rigid cover plate on the side facing away from the back plate, so that the entire surface of the cover plate is available for gently guiding and receiving the tablet in the frame member or mounting system.

Preferably, the rigid cover plate completely covers the receiving space so that the entire surface of the receiving space is available for or contributes to the gentle guidance and receiving of the tablet in the frame member or mounting system. Also, in this embodiment, all openings and/or holes and/or receptacles in the back plate can be covered by the rigid cover plate. The enlarged covering layer also creates a uniform surface in the entire receiving space.

Furthermore, the rigid cover plate can preferably be magnetically connected to the back plate in order to realize easy detachability and thus interchangeability of the cover plate. As part of this embodiment, the rigid cover plate can preferably be made of metal and the back plate can comprise a magnetic material, whereby the magnetic material can preferably be designed as at least one discrete (individual) magnet in a corresponding magnet recess in the back plate. The embodiment with one or more magnets is advantageous in that only parts of the back plate need to have magnetic properties. This means that magnetic material can be saved and the magnet recesses in the back plate are not visible when the rigid cover plate is mounted, provided that the extension of the back plate is sufficient. Furthermore, the back plate can advantageously be made of a non-magnetic material, such as aluminium.

Furthermore, the covering layer can preferably also be bonded to the rigid cover plate with an adhesive. Lamination is also conceivable according to the invention, whereby the adhesive connection is the preferred connection of the rigid cover plate to the covering layer due to its easier manufacturability.

According to a preferred embodiment, the guide extends along the entire inner side of the frame member. Thus, in particular, a better guide and/or a more stable retention of the tablet in the frame member or in the mounting system can be achieved. It should be noted that, according to the invention, the guide can have a guiding function when the tablet is inserted into the frame member and/or a holding function when the tablet has been inserted into the frame member.

In a preferred further development, the guide can be formed between a protrusion on the inner side of the frame member and the back plate, so that the tablet can be inserted into the mounting system and held between the protrusion and the back plate. Advantageously, the protrusion is formed in one piece with the frame member. If the frame member is formed in one piece with the back plate, the protrusion can also be part of an entire one-piece arrangement of frame member and back plate.

In another preferred further development, the covering layer can be made of leather or imitation leather, preferably with a roughened surface on a side facing away from the rigid cover plate. The roughened surface has good guiding properties for the tablet and at the same time protects the tablet during its insertion into the frame member. In addition, a covering layer made of leather or imitation leather provides a soft, pleasant appearance.

In a further preferred embodiment, the imitation leather consists of microfibers, in particular microfibers with a roughened surface on the side facing away from the rigid cover plate. Microfiber materials, such as for example Alcantara leather or the like, are easy to process and have the appearance and/or properties of a non-woven fabric with a suede character. Such microfiber materials are known and available in various surface weights using ultra-fine polyester fibers in the prior art.

In an equally preferred embodiment of the mounting system according to the invention, the guide is provided with a lining which is formed as a sliding film, wherein the lining extends at least in a portion of the guide, in particular in the portion of the guide into which the tablet is inserted in a sliding manner during its insertion into the mounting system. The sliding film simultaneously protects the tablet during and after its insertion into the frame member, as direct contact of the tablet frame with the guide is minimized. This is particularly advantageous if the guide is made of a metal, such as aluminium.

Furthermore, according to a preferred aspect of the invention, an inserting portion of the guide, at which the insertion of the tablet into the guide is initiated, can have a rounded or bevelled edge. This further facilitates the insertion of the tablet into the frame member and reduces the risk of damage to the tablet frame, such as could occur on sharp edges.

Furthermore, according to a further preferred aspect of the invention, the mounting system can be designed as a wall mounting system with a fastening means for fastening to a wall or the like, the fastening means preferably having at least one screw and a matching through-hole in the back plate. Alternatively, the mounting system can also be formed as a table mounting system, whereby the mounting system has, for example, a support, in particular a fold-out support. The table mounting system can also be formed with a flat or bevelled base.

According to the invention, the mounting system can advantageously be formed with an electrical contact which is provided in the guide and is adapted for connection to a corresponding mating element on the tablet, wherein the electrical contact is provided with a cable, preferably for connection to an external power source. The electrical contact can, for example, be formed as a USB plug or as a Lightning plug or the like. The contact can preferably also have a holding function for the tablet in the inserted state.

A further preferred embodiment of the invention relates to a recess formed in the back plate for receiving the rigid cover plate. This allows the rigid cover plate to be better and more securely positioned and received in the back plate. This improves the overall stability of the mounting system.

According to a further preferred aspect of the invention, the back plate has a recess on a side which is not surrounded by the frame member in order to facilitate removal of the rigid cover plate from the back plate using a suitable tool.

Further preferably, the frame member can be formed on its inner side substantially as a rectangle with one or two missing sides. Further preferred is a square with one or two missing sides and the frame member is part of a circle surrounding the square.

The invention is explained in more detail below with reference to the drawings in which:

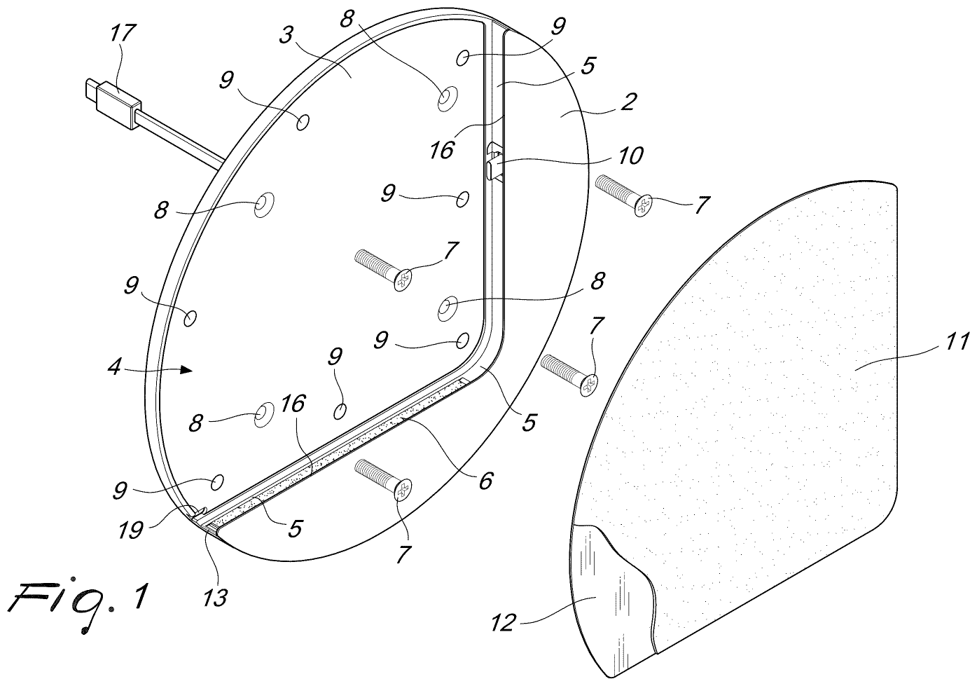

FIG. 1 shows a perspective exploded view of an embodiment of the mounting system according to the invention from the front, which is formed as a wall mounting system, with the back plate removed;

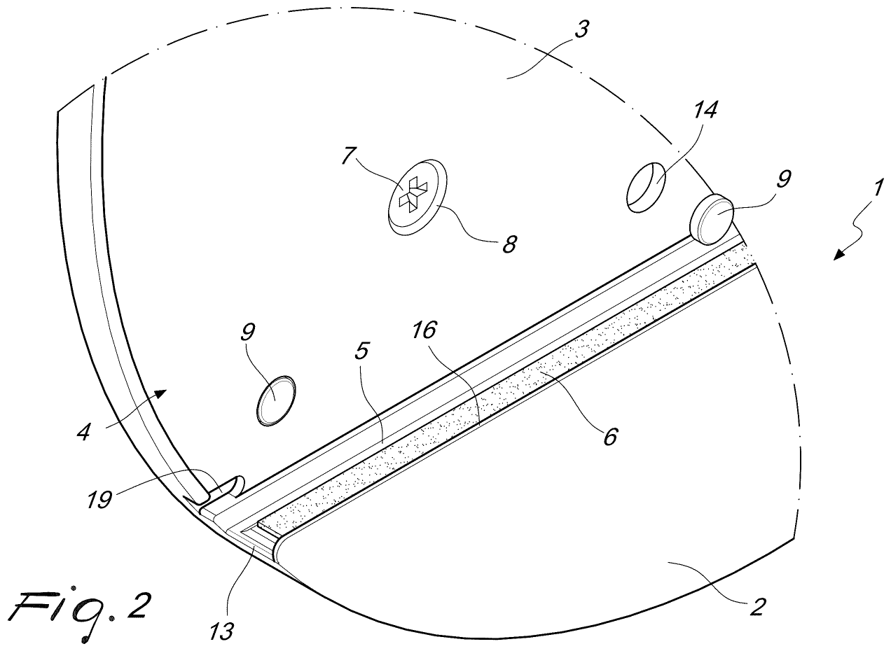

FIG. 2 shows an enlarged view of the insertion portion of the mounting system in FIG. 1 with the back plate removed;

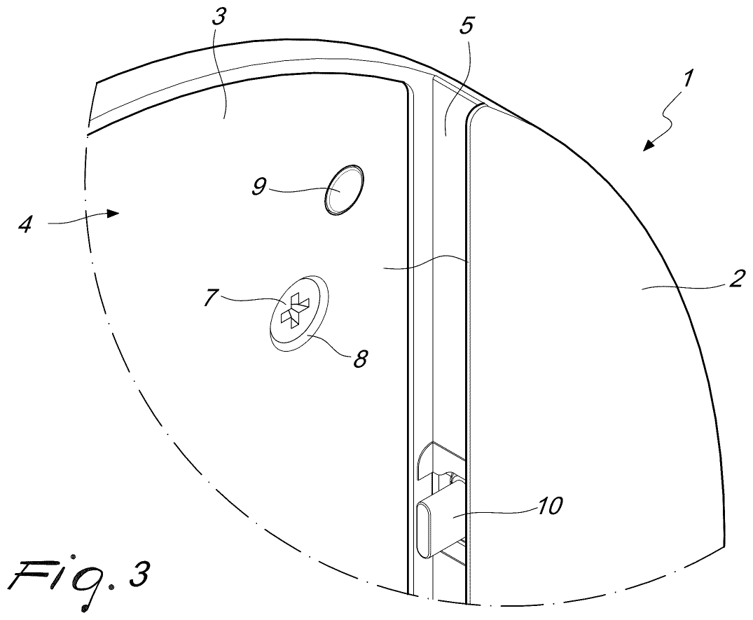

FIG. 3 shows an enlarged view of the contact portion of the mounting system in FIG. 1 with the back plate removed;

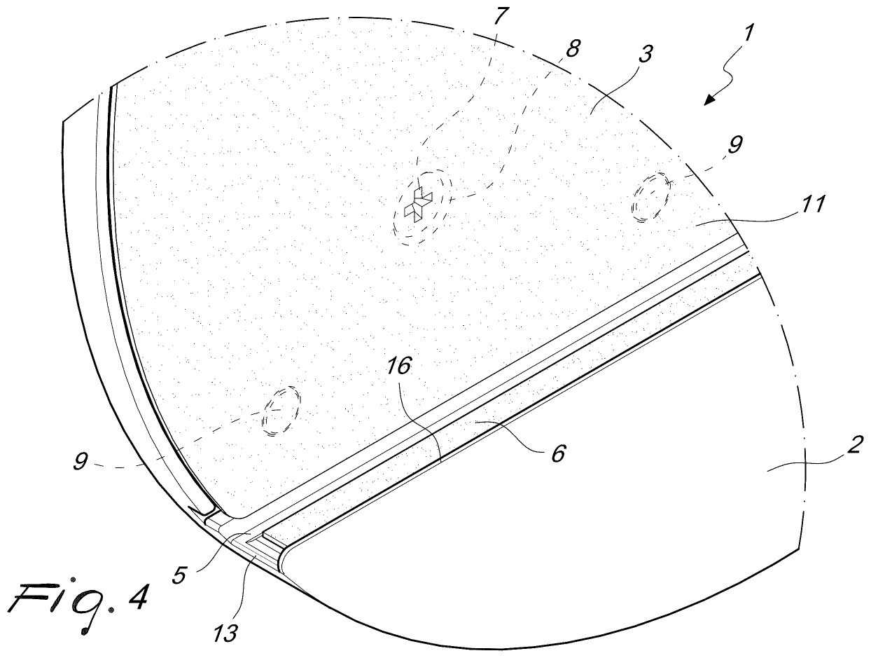

FIG. 4 shows an enlarged view of the insertion portion of the mounting system in FIG. 1 with the back plate inserted;

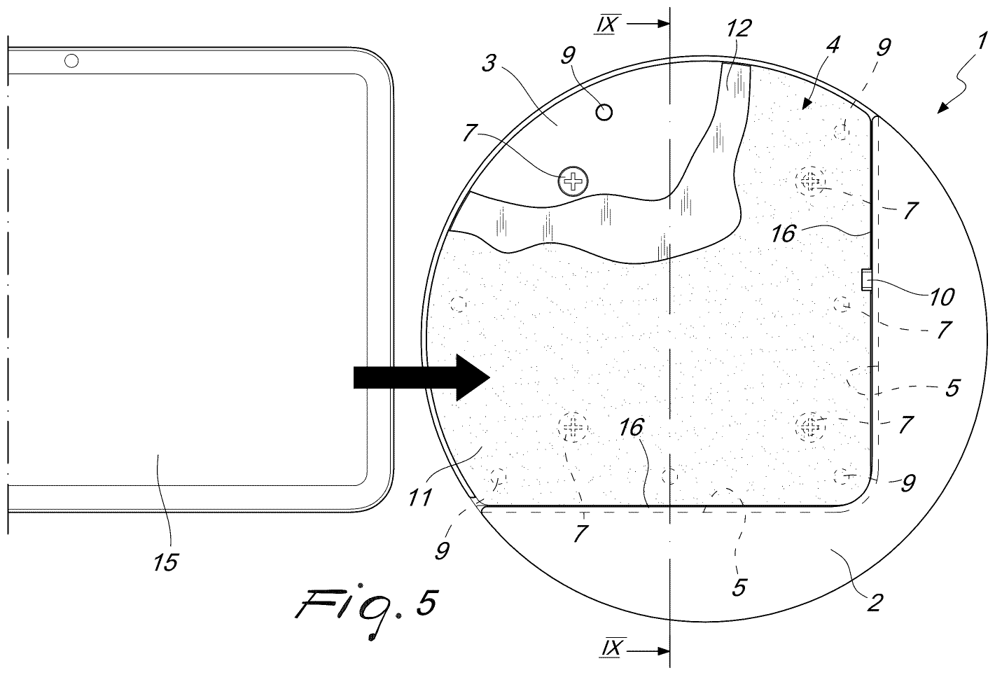

FIG. 5 shows a front view of the mounting system of FIG. 1 before the tablet is inserted;

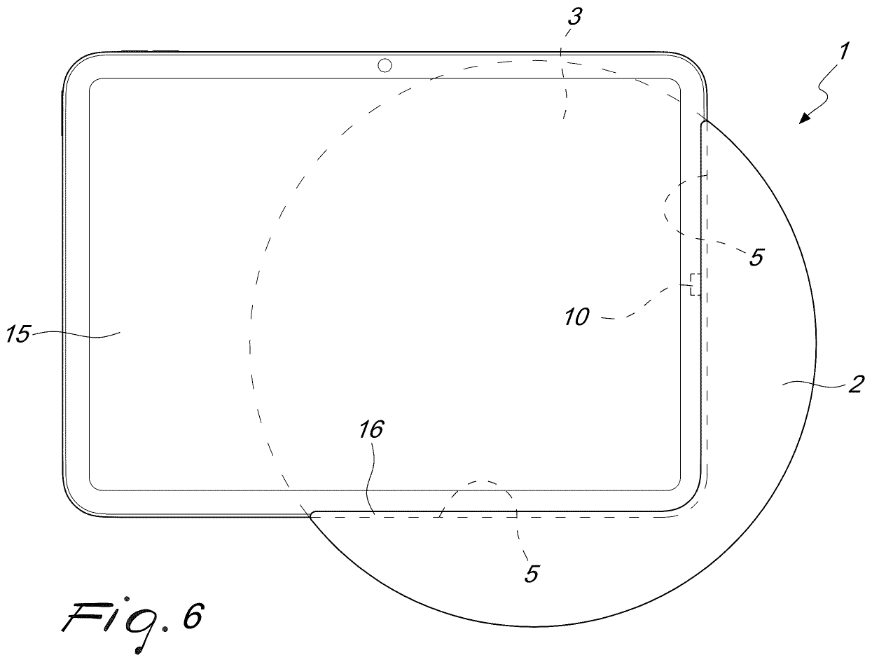

FIG. 6 shows a front view of the mounting system of FIG. 1 after the tablet has been inserted;

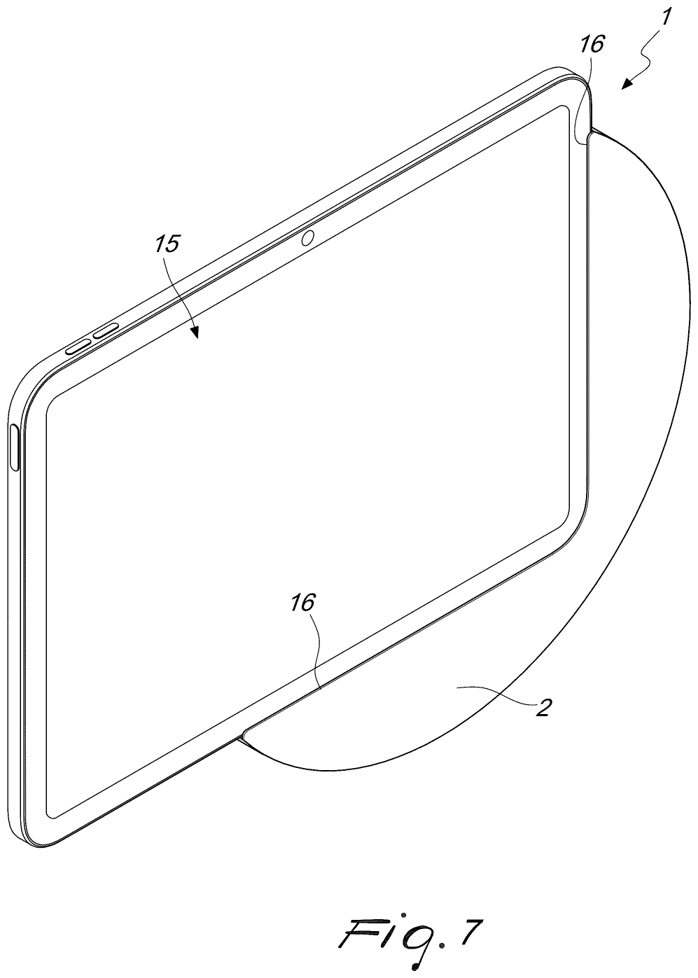

FIG. 7 shows a perspective view of the mounting system with inserted tablet of FIG. 6;

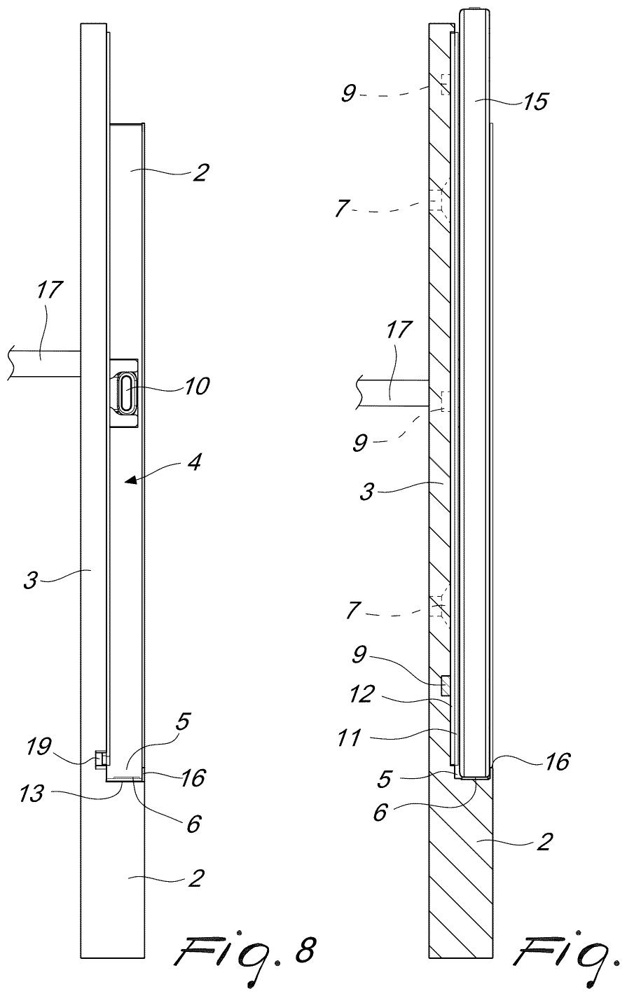

FIG. 8 shows a side view of the mounting system in FIG. 1 without the tablet inserted;

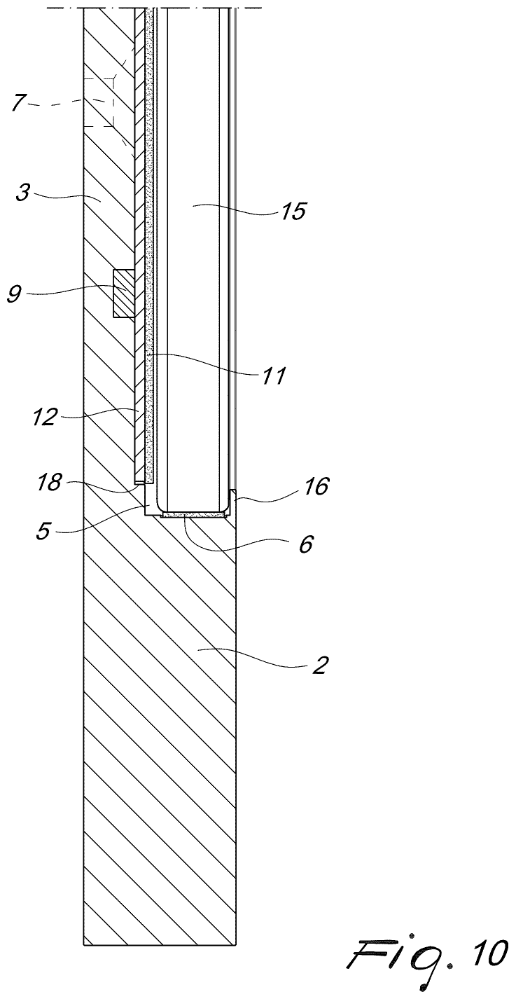

FIG. 9 shows a sectional view of the mounting system along line IX-IX of FIG. 5 with the tablet inserted;

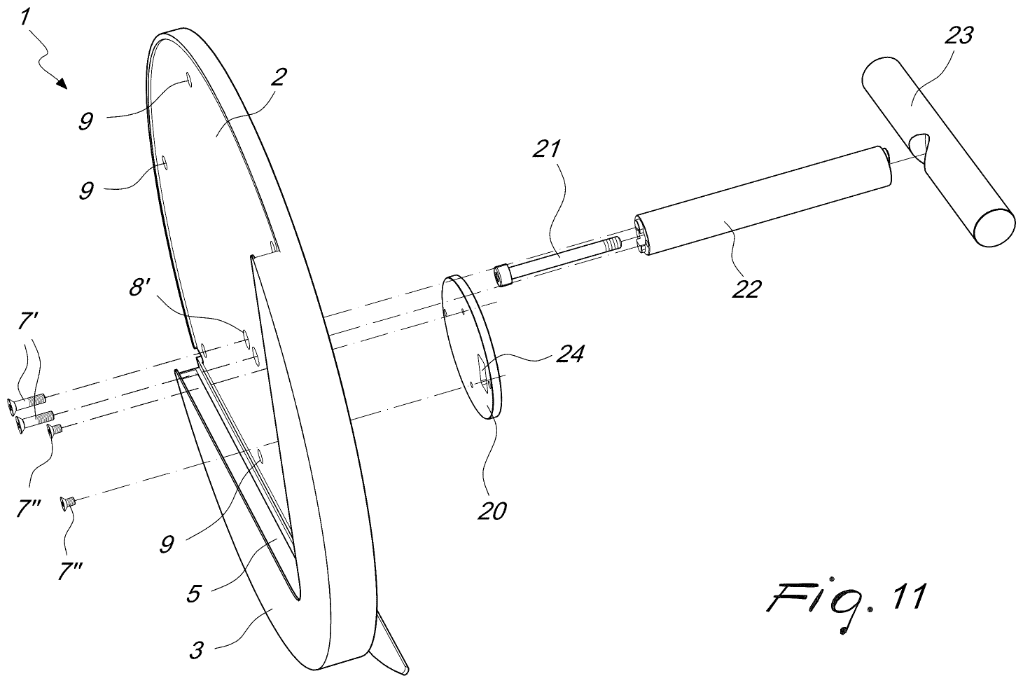

FIG. 10 shows an enlarged view of the lower portion of the mounting system of FIG. 9;

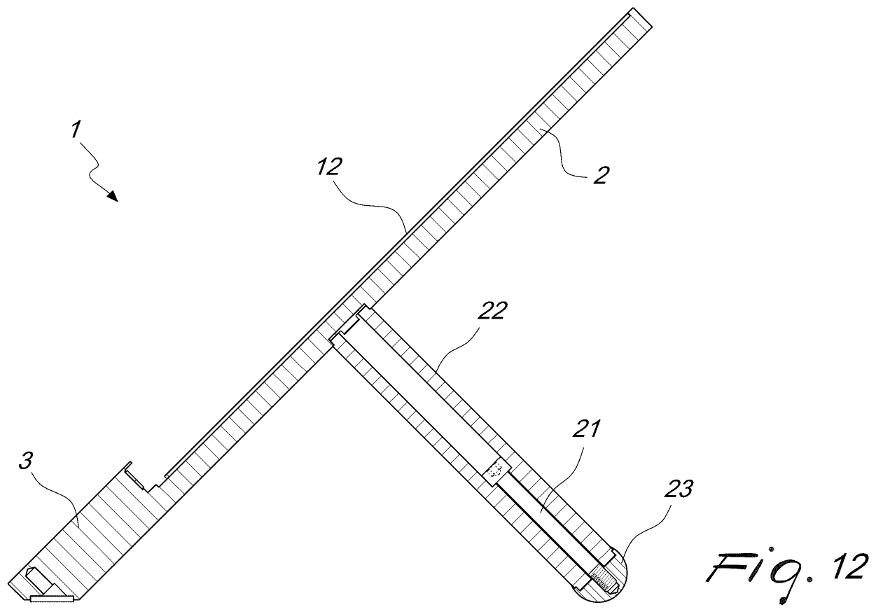

FIG. 11 is an exploded perspective view of one embodiment of the mounting system according to the invention as a table mounting system; and

FIG. 12 is a sectional view of the table mounting system of FIG. 11.

Embodiments of the mounting system 1 according to the invention are shown, for example, in the figures of the invention.

With reference to FIGS. 1 to 10, mounting systems 1 formed as wall mounting systems according to the invention comprise a frame member 2 and a back plate 3. The embodiments of the invention formed as table mounting systems are identical in terms of structure to the embodiments formed as wall mounting systems, apart from the means provided exclusively for wall mounting. The fastening means in the table mounting systems are adapted accordingly for the attachment of a support.

As shown in FIG. 1, for example, the frame member 2 partially surrounds the back plate 3 in such a way that a tablet 15 can be inserted into the frame member 2. The back plate 3 and the frame member 2 preferably form a unit and are firmly connected to each other. The frame member 2 and the back plate 3 are preferably formed in one piece and/or the frame member 2 and the back plate 3 are made of aluminium. The frame member 2 and the back plate 3 can be cast or manufactured by CNC milling or the like. The frame member 2 and the back plate 3 can be manufactured as separate parts and later joined to form a single unit. Other materials such as metal or plastic are also conceivable for producing the frame member 2 and the back plate 3, as are combinations of different materials. Coated materials can also be used to manufacture the frame member 2 and/or the back plate 3. The frame member 2 can also have a roughened surface, made for example by sandblasting.

With further reference to FIG. 1, the frame member 2 and the back plate 3 define a receiving space 4 for the tablet 15 on an inner side of the frame member 2. The outline of the receiving space 4 is preferably part of a cuboid with two missing sides, although a cuboid with one missing side is also conceivable. In any case, according to the invention, the opening of the outline should be dimensioned such that the insertion of the tablet 15 is possible. Other rectangular shapes are also conceivable, where at least one side of the rectangle must be missing so that the insertion of a tablet 15 is possible.

With further reference to FIGS. 1 to 5 and 8 to 10, the mounting system 1 according to the invention has a guide 5 which extends at least partially on the inner side of the frame member 2 and is designed for inserting and receiving the tablet 15 in the receiving space 4. The guide 5 advantageously has a guiding function when the tablet 15 is inserted into the frame member 2 and/or a holding function when the tablet 15 is inserted into the frame member 2.

With further reference to FIGS. 1 to 10, the mounting system 1 according to the invention has a rigid cover plate 12, which is detachably connected to the back plate 3 and at least partially covers the receiving space 4. Due to the rigid cover plate 12, it is advantageously possible to provide openings or holes or receptacles or apertures in the back plate 3 without impairing the stability of the mounting system 1 and/or the holding capacity or guiding capacity of the back plate 3. In particular, larger openings or holes and the like can thus be realized, which in particular take up more than 10% or more than 20% or even more than 50% of the surface of the back plate 3.

With further reference to FIGS. 1 to 10, the mounting system 1 according to the invention has a covering layer 11 made of leather, imitation leather or non-woven fabric, which at least partially covers the rigid cover plate 12 on a side facing away from the back plate 3 and which is firmly connected to the rigid cover plate 12.

Preferably, the rigid cover plate 12 completely covers the receiving space 4. This provides a uniform appearance regardless of the nature of the back plate 3 and increases the stability and holding capacity of the mounting system 1.

Preferably, the covering layer 11 completely covers the rigid cover plate 12 on the side facing away from the back plate 3, so that the entire surface of the cover plate 12 is available for gently guiding and receiving the tablet 15 in the frame member 2 or the mounting system 1, respectively, and so that the entire surface of the receiving space 4 is also available for gently guiding and receiving the tablet 15 in the frame member 2 or in the mounting system 1, respectively. In this configuration, all openings and/or holes and/or receptacles and/or apertures of the back plate 3 can also be cached by the rigid cover plate 12. The enlarged covering layer 11 also creates a uniform surface in the entire receiving space 4.

As shown in the figures, the rigid cover plate 12 is particularly preferably magnetically connected to the back plate 3, wherein the rigid cover plate 12 is further preferably formed of metal and the back plate 3 comprises a magnetic material and wherein further preferably the magnetic material is formed as at least one discrete magnet 9 in a corresponding magnet recess 14 in the back plate 3. As shown in the figures, a plurality of magnets 9 can be provided in corresponding magnet recesses 14 in the back plate 3, wherein a better distributed attraction force between the back plate 3 and the rigid cover plate 12 is realized by the distribution of the magnets 9 in the back plate 3. The rigid cover plate 12 allows the number and size of the magnet recesses 14 to be maximized, where the complete covering of the back plate 3 by the cover plate 12 is particularly advantageous in this context.

The covering layer 11 can be bonded to the rigid cover plate 2 with an adhesive or can be laminated onto it. Due to its easier manufacturability, the adhesive connection is the preferred connection of the rigid cover plate 12 to the covering layer 11 according to the invention.

According to a preferred embodiment, the guide 5 extends along the entire inner side of the frame member 2. Thus, in particular, a better guide and/or a more stable holding of the tablet 15 in the frame member 2 or in the mounting system 1, respectively, can be achieved. It should be noted that, as explained above, the guide 5 according to the invention can have a guiding function when the tablet 15 is inserted into the frame member 2 and/or a holding function when the tablet 5 has been inserted into the frame member 2.

As shown in particular in FIGS. 8 to 10, the guide 5 can advantageously be formed between a protrusion 16 on the inner side of the frame member 2 and the back plate 3, so that the tablet 15 can be inserted into the mounting system 1 and held between the protrusion 16 and the back plate 3. Advantageously, the protrusion 16 is formed in one piece with the frame member 2. If the frame member 2 is formed in one piece with the back plate 3, the protrusion 16 can also be part of an entire one-piece arrangement of frame member 2 and back plate 3.

Preferably, the covering layer 11 can be made of leather or imitation leather and preferably have a roughened surface on a side facing away from the rigid cover plate 12. The roughened surface of the covering layer 11 has good guiding properties for the tablet 15 and at the same time protects the tablet 15 during its insertion into the frame member 2. In addition, a covering layer 11 made of leather or imitation leather provides a soft, pleasant appearance of the mounting system 1.

In a further preferred embodiment, the imitation leather consists of microfibers, in particular microfibers, with a roughened surface on the side facing away from the rigid cover plate 12. Microfiber materials, such as Alcantara leather, are easy to process and have the appearance and/or properties of a nonwoven fabric with a suede character. Such microfiber materials known in the prior art are available with various surface weights using ultra-fine polyester fibers. Alcantara leather is a preferred imitation leather of the invention due to its availability, variety of colors and processability.

In an equally preferred embodiment of the mounting system 1 according to the invention, the guide 5 is provided with a lining 6 which is designed as a sliding film, wherein the lining 6 extends at least in a portion of the guide 5, in particular in the portion of the guide 5 into which the tablet 15 is inserted in a sliding manner during its insertion into the mounting system 1. One possible extension of the portion is shown in FIG. 1 and corresponds to the side or sides of the frame member 2 on which there is no electrical contact as described below. The sliding film also protects the tablet 5 during and after its insertion into the frame member 2, as direct contact of the tablet frame with the guide 5 is minimized. This is particularly advantageous if the guide 5 is made of a metal, such as aluminium.

Sliding films are particularly preferred according to the invention, as they are particularly suitable for lining tribologically stressed surfaces and shapes, for optimizing transport and guiding tasks of guides and as edge protection.

Glued-on sliding films are also particularly preferred. By simply sticking on the sliding film, surfaces that slide against each other are protected during movement. The noise level is reduced by the smooth sliding action. The ease of processing (i.e. cutting to size using scissors) and the optional self-adhesive backing make it easy to use.

A Tribo-Tape sliding film from IGUS GmbH in Cologne, Germany, is the preferred sliding film.

Furthermore, according to a preferred aspect of the invention, which can be clearly seen in particular in FIG. 2, an insertion area 13 of the guide 5, at which the insertion of the tablet 15 into the guide 5 can be initiated, can have a rounded or bevelled edge. This also makes it easier to insert the tablet 5 into the frame member 2 and reduces the risk of damage to the tablet frame, such as could occur on sharp edges.

Furthermore, according to a further preferred aspect of the invention shown in FIGS. 1 to 10, the mounting system 1 can be formed as a wall mounting system with a fastening means for fastening it to a wall or the like, wherein preferably the fastening means comprises at least one screw 7 and a matching through hole 8 in the back plate 3. The rigid cover plate 12 allows the number and size of the through holes 8 to be maximized, with the complete covering of the back plate 3 by the cover plate 12 being particularly advantageous in this context.

As shown, for example, in FIGS. 1 and 3, the mounting system 1 can advantageously according to the invention be formed with an electrical contact 10, which is provided in the guide 5 and is formed for connection to a corresponding mating element on the tablet 15, wherein the electrical contact 10 is provided with a cable 17, preferably for connection to a power source which is not shown. The electrical contact 10 can, for example, be formed as a USB connector, in particular, as shown, as a USB-C connector, or Lightning connector or the like. The electrical contact 10 can preferably also have a holding function for the tablet 15 in the inserted state.

A further preferred embodiment of the invention, as shown for example in FIGS. 9 and 10, relates to a recess 18 formed in the back plate 3 for receiving the rigid cover plate 12. This allows the rigid cover plate 12 to be better and more securely positioned and received in the back plate 3. This improves overall stability of the mounting system 1.

According to a further preferred aspect of the invention, as shown for example in FIGS. 1 and 8, the back plate 3 has a recess 19 on one side which is not surrounded by the frame member 2 in order to facilitate removal of the rigid cover plate 12 from the back plate 3 using a suitable tool or manually.

Further preferably, the frame member 2, as shown in FIG. 1, can be formed on its inner side essentially as a square with two missing sides. Other rectangular shapes are also conceivable according to the invention, provided that at least one side of the rectangle is free for the insertion of the tablet 15.

With reference to FIGS. 11 and 12, an embodiment of the mounting system 1 as a table mount is described. This embodiment differs from the mounting system 1 formed as a wall mount in that a support or base is also provided in order to support the mounting system 1 on a support, such as a table.

The support can be formed in one piece or, as shown in FIGS. 11 and 12, in two pieces. In particular, the support can have a first support element 22 and a second support element 23 extending perpendicularly thereto, a screw 21 being provided for fastening the two support elements 22 and 23. The support can be hinged or fixed.

At least one additional screw 7′ is provided for fastening the support to the back plate 3, the at least one additional screw 7′ being guided through a corresponding through-hole 8′ and fastening the support to the back plate 3.

Furthermore, FIG. 11 shows a cover element 20 for a space in the back plate 3 and/or in the frame member 2, through which the cable 17 is guided and routed to the outside. The cover element 20 has an opening 24 for this purpose. The cover element 20 can be attached to the back plate 3 by further screws 7″ and corresponding through-holes in the back plate 3. The opening 24 of the cover element 20 can advantageously have a plug or socket for the external power supply or the like of the tablet 15.

The embodiment with a space in the back plate 3 and/or in the frame member 2 can of course be used in conjunction with all embodiments of the invention, and the plug shown with the cable 17 can be inserted into the opening 20 of the cover 20 in all embodiments.

It will be understood that when an element is described as being “on”, “connected to”, “coupled to” or “in contact with” another element, the element may then be directly on, connected to or coupled to the other element, or there may also be intervening elements which either only intervene or connect or couple the element to the other element or keep them in contact. If, on the other hand, an element is described as being “directly on” another element, “directly connected”, “directly coupled” or “directly in contact” with it, this is to be understood as meaning that there are no intervening elements.

Although the terms “first”, “second”, etc. may be used herein to designate various elements, components, areas and/or sections, these elements, components, areas and/or sections are not limited by these terms. The expressions are only used to distinguish one element, component, area or section from another element, another component, area or section. Therefore, a first element, component, area or section discussed below may be referred to as a second element, component, area or section without departing from the teachings of the present invention.

Embodiments of the invention are described herein with reference to views which are schematic representations of embodiments of the invention. Therefore, the actual thickness of the components may differ therefrom, and variations from the shapes in the illustrations, for example due to manufacturing processes and/or tolerances, are to be expected. Embodiments of the invention are not to be understood as limited to the specific shapes of the areas shown herein, but are intended to include variations in shapes resulting from, for example, the method of manufacture. An area shown or described as square or rectangular typically also has rounded or curved features due to normal manufacturing tolerances. Therefore, the areas shown in the figures are schematic in nature, and their shapes are not intended to represent the exact shape of an area of a device or to limit the scope of protection of the invention.

With respect to the term “comprising”, it must be said for clarity that when a first device part comprises a second device part, this means that the second device part “belongs to” the first device part and not necessarily that the first device part encloses it in terms of arrangement, unless it is, for example, a description of a positional and shape arrangement.

Further possible embodiments are described in the following claims. In particular, the various features of the embodiments described above can also be combined with one another, provided they are not technically mutually exclusive.

The reference signs mentioned in the claims are only indicated for more clarity and do not limit the claims in any way to the embodiments shown in the figures.

The embodiments shown here are only examples of the present invention and must therefore not be understood to be limiting. Alternative embodiments contemplated by the person skilled in the art are equally encompassed by the scope of protection of the present invention.

The present invention can be further described by the following Items.

Item 1: A mounting system (1) for a tablet (15), the mounting system (1) comprising: a frame member (2); a back plate (3) which is partially surrounded by the frame member (2), wherein the frame member (2) and the back plate (3) define a receiving space (4) for the tablet (15) on an inner side of the frame member (2); a guide (5) which extends at least partially on the inner side of the frame member (2) and is formed for insertion and receiving of the tablet (15) in the receiving space (4); a rigid cover plate (12) which is detachably connected to the back plate (3) and at least partially covers the receiving space (4); and a covering layer (11) made of leather, imitation leather or non-woven fabric, which at least partially covers the rigid cover plate (12) on a side facing away from the back plate (3) and which is firmly connected to the rigid cover plate (12).

Item 2: The mounting system (1) for a tablet (15) according to Item 1, wherein the covering layer (11) completely covers the rigid cover plate (12) on the side facing away from the back plate (3).

Item 3: The mounting system (1) for a tablet (15) according to Items 1 or 2, wherein the rigid cover plate (12) completely covers the receiving space (4).

Item 4: The mounting system (1) for a tablet (15) according to one or more of the preceding Items, wherein the rigid cover plate (12) is magnetically connected to the back plate (3) and wherein the rigid cover plate (12) is preferably formed of metal and the back plate (3) comprises a magnetic material and wherein the magnetic material is further preferably formed as at least one discrete magnet (9) in a corresponding magnet recess (14) of the back plate (3) and/or wherein the covering layer (11) is bonded or laminated to the rigid cover plate (2) by means of an adhesive.

Item: 5. The mounting system (1) for a tablet (15) according to one or more of the preceding Items, wherein the guide (5) extends along the entire inner side of the frame member (2).

Item: 6. The mounting system (1) for a tablet (15) according to one or more of the preceding Items, wherein the guide (5) is formed between a protrusion (16) on the inner side of the frame member (2) and the back plate (3), so that the tablet (15) can be inserted into the mounting system (1) between the protrusion (16) and the back plate (3) and can be held.

Item: 7. The mounting system (1) for a tablet (15) according to one or more of the preceding Items, wherein the covering layer (11) is made of leather or imitation leather and preferably has a roughened surface on a side facing away from the rigid cover plate (12).

Item: 8. The mounting system (1) for a tablet (15) according to Item 7, wherein the imitation leather consists of microfibers, in particular of microfibers with a roughened surface on the side facing away from the rigid cover plate (12).

Item: 9. The mounting system (1) for a tablet (15) according to one or more of the preceding Items, wherein the guide (5) is provided with a lining (6) which is designed as a sliding film, wherein the lining (6) extends at least in a portion of the guide (5), in particular in the portion of the guide (5) into which the tablet (15) is inserted in a sliding manner during its insertion into the mounting system (1).

Item: 10. The mounting system (1) for a tablet (15) according to one or more of the preceding Items, wherein an insertion an insertion area (13) of the guide (5), at which the insertion of the tablet (15) into the guide (5) is initiated, has a rounded or bevelled edge.

Item: 11. The mounting system (1) for a tablet (15) according to one or more of the preceding Items, wherein the mounting system (1) is formed as a wall mounting system with a fastening means (7, 8) for being fastened to a wall or the like, wherein the fastening means (7, 8) has at least one screw (7) and a matching through-hole (8) in the back plate (3), or wherein the mounting system (1) is formed as a table mounting system with a support (22, 23), in particular a fold-out support.

Item: 12. The mounting system (1) for a tablet (15) according to one or more of the preceding Items, wherein the mounting system (1) is formed with an electrical contact (10) which is provided in the guide (5) and is formed for connection to a corresponding mating element on the tablet (15), wherein the electrical contact (10) is provided with a cable (17), preferably for connection to a power source.

Item: 13. The mounting system (1) for a tablet (15) according to Item 12, wherein the cable (17) is guided through a space in the back plate (3) and/or in the frame member (2) and is led out through an opening (24) in a cover element (20) of the space, wherein the cover element (20) is preferably removable.

Item: 14. The mounting system (1) for a tablet (15) according to one or more of the preceding Items, wherein the back plate (3) is formed with a recess (18) for receiving the rigid cover plate (12).

Item: 15. The mounting system (1) for a tablet (15) according to one or more of the preceding Items, wherein the back plate (3) comprises a recess (19) on a side not surrounded by the frame member (2) to facilitate removal of the rigid cover plate (12) from the back plate (3) with a suitable tool.

Item: 16. The mounting system (1) for a tablet (15) according to one or more of the preceding Items, wherein the frame member (2) is formed on its inner side substantially as a rectangle with one or two missing sides.

Item: 17. The mounting system (1) for a tablet (15) according to one or more of the preceding Items, wherein the frame member (2) and the back plate (3) are formed in one piece and/or wherein the frame member (2) and the back plate (3) are made of aluminium; or wherein the frame member (2), the guide (5) and the back plate (3) are formed in one piece and/or wherein the frame member (2), the guide (5) and the back plate (3) are made of aluminium.

### LIST OF REFERENCE NUMBERS

1 Mounting system
2 Frame member
3 Back plate
4 Receiving space
5 Guide
6 Lining
7 Screws for wall mounting
7′ Screws for fastening the support of the table version
7″ Screws for fastening the cover element
8 Through-holes for wall mounting
8′ Through-holes for the screws for fastening the support of the table version
9 Magnets
10 Electrical contact
11 Covering layer made of leather, imitation leather or non-woven fabric
12 Rigid cover plate
13 Guide insertion area
14 Magnetic recesses
15 Tablet
16 Protrusion of the guide
17 Cables
18 Recess in the back plate for accommodating the rigid cover plate
19 Recess for removing the rigid cover plate from the back plate
20 Cover element
21 Screw for connecting the first and second support elements of the support
22 First support element
23 Second support element
24 Opening of the cover element

The invention claimed is:

1. A mounting system for a tablet, the mounting system comprising:
a frame member;
a back plate which is partially surrounded by the frame member, wherein the frame member and the back plate define a receiving space for the tablet on an inner side of the frame member;
a guide which extends at least partially on the inner side of the frame member and is formed for insertion and receiving of the tablet in the receiving space;
a rigid cover plate which is detachably connected to the back plate and at least partially covers the receiving space; and
a covering layer made of leather, imitation leather or non-woven fabric, which at least partially covers the rigid cover plate on a side facing away from the back plate and which is firmly connected to the rigid cover plate.

2. The mounting system for a tablet according to claim 1, wherein the covering layer completely covers the rigid cover plate on the side facing away from the back plate.

3. The mounting system for a tablet according to claim 1, wherein the rigid cover plate completely covers the receiving space.

4. The mounting system for a tablet according to claim 1, wherein the rigid cover plate is magnetically connected to the back plate and wherein the rigid cover plate is preferably formed of metal and the back plate comprises a magnetic material and wherein the magnetic material is further preferably formed as at least one discrete magnet in a corresponding magnet recess of the back plate.

5. The mounting system for a tablet according to claim 1, wherein the covering layer is bonded or laminated to the rigid cover plate by means of an adhesive.

6. The mounting system for a tablet according to claim 1, wherein the guide extends along the entire inner side of the frame member.

7. The Mounting system for a tablet according to claim 1, wherein the guide is formed between a protrusion on the inner side of the frame member and the back plate, so that the tablet can be inserted into the mounting system between the protrusion and the back plate and can be held.

8. The mounting system for a tablet according to claim 1, wherein the covering layer is made of leather or imitation leather and preferably has a roughened surface on a side facing away from the rigid cover plate.

9. The mounting system for a tablet according to claim 8, wherein the imitation leather consists of microfibers, in particular of microfibers with a roughened surface on the side facing away from the rigid cover plate.

10. The mounting system for a tablet according to claim 1, wherein the guide is provided with a lining which is designed as a sliding film, wherein the lining extends at least in a portion of the guide, in particular in the portion of the guide into which the tablet is inserted in a sliding manner during its insertion into the mounting system.

11. The mounting system for a tablet according to claim 1, wherein an insertion an insertion area of the guide, at which the insertion of the tablet into the guide is initiated, has a rounded or bevelled edge.

12. The mounting system for a tablet according to claim 1, wherein the mounting system is formed as a wall mounting system with a fastening means for being fastened to a wall or the like, wherein the fastening means has at least one screw and a matching through-hole in the back plate, or wherein the mounting system is formed as a table mounting system with a support, in particular a fold-out support.

13. The mounting system for a tablet according to claim 1, wherein the mounting system is formed with an electrical contact which is provided in the guide and is formed for connection to a corresponding mating element on the tablet, wherein the electrical contact is provided with a cable, preferably for connection to a power source.

14. The mounting system for a tablet according to claim 13, wherein the cable is guided through a space in the back plate and/or in the frame member and is led out through an opening in a cover element of the space, wherein the cover element is preferably removable.

15. The mounting system for a tablet according to claim 1, wherein the back plate is formed with a recess for receiving the rigid cover plate.

16. The mounting system for a tablet according to claim 1, wherein the back plate comprises a recess on a side not surrounded by the frame member to facilitate removal of the rigid cover plate from the back plate with a suitable tool.

17. The mounting system for a tablet according to claim 1, wherein the frame member is formed on its inner side substantially as a rectangle with one or two missing sides.

18. The mounting system for a tablet according to claim 1, wherein the frame member and the back plate are formed in one piece and/or wherein the frame member and the back plate (3) are made of aluminium.

19. The mounting system for a tablet according to claim 1, wherein the frame member, the guide and the back plate are formed in one piece and/or wherein the frame member, the guide and the back plate are made of aluminium.
